(19) United States
(12) Patent Application Publication
(10) Pub. No.: US 2026/0254693 A1
(43) Pub. Date: Aug. 27, 2026

(54) TECHNIQUES FOR SOUNDING REFERENCE SIGNAL (SRS) OPERATION WITH EIGHT PORTS

(71) Applicant: Intel Corporation, Santa Clara, CA (US)

(72) Inventors: Guotong WANG, Beijing (CN); Bishwarup MONDAL, San Ramon, CA (US)

(21) Appl. No.: 18/992,866

(22) PCT Filed: Aug. 7, 2023
(86) PCT No.: PCT/US2023/071787

§ 371 Date: Jan. 9, 2025

Related U.S. Application Data
(60) Provisional application No. 63/485,611, filed on Feb. 17, 2023.

(30) Foreign Application Priority Data
Aug. 10, 2022 (WO) PCT/CN2022/111346

(51) Int. Cl. H04L 27/26; H04L 1/00

(52) U.S. Cl. CPC H04L 27/261; H04L 1/0061

(57) ABSTRACT

Systems, apparatuses, methods, and computer-readable media are provided for sounding reference signal (SRS) transmission with eight antenna ports. For example, one SRS resource with multiple orthogonal frequency division multiplexing (OFDM) symbols may be configured. Alternatively, multiple SRS resources may be configured to enable 8-port operation. Other embodiments may be described and claimed.

### CROSS REFERENCE TO RELATED APPLICATION

The present application claims priority to International Patent Application No. PCT/CN2022/111346, which was filed Aug. 10, 2022; and to U.S. Provisional Patent Application No. 63/485,611, which was filed Feb. 17, 2023.

### FIELD

Various embodiments generally may relate to the field of wireless communications. For example, some embodiments may relate to sounding reference signal (SRS) operation with eight ports.

### BACKGROUND

In Third Generation Partnership Project (3GPP) New Radio (NR) Releases 15, 16, and 17, up to 4 ports are supported for sounding reference signal (SRS) operation. However, future specifications may support more than 4 ports, such as 8 ports. The existing techniques are not suitable for more than 4 ports.

### BRIEF DESCRIPTION OF THE FIGURES

FIGS. 1A and 1B illustrates a radio resource control (RRC) configuration of a sounding reference signal (SRS) resource.

FIG. 2 illustrates an example of 8-port SRS operation via one SRS resource with two symbols, in accordance with various embodiments.

FIG. 3 illustrates an example of 8-port SRS operation via one SRS resource with four symbols and each symbol is mapped with two ports, in accordance with various embodiments.

FIG. 4 illustrates an example of SRS port mapping over multiple orthogonal frequency division multiplexing (OFDM) symbols in half-half manner, in accordance with various embodiments.

FIG. 5 illustrates an example of SRS port mapping over multiple OFDM symbols in interlaced manner, in accordance with various embodiments.

FIG. 6 illustrates an example of SRS port mapping over multiple OFDM symbols in sequential manner, in accordance with various embodiments.

FIG. 7 illustrates an example of 8-port SRS frequency hopping via one SRS resource with two symbols, in accordance with various embodiments.

FIG. 8 illustrates another example of 8-port SRS frequency hopping via one SRS resource with two symbols, in accordance with various embodiments.

FIG. 9 illustrates an example of 8-port SRS operation via two 4-port SRS resources, in accordance with various embodiments.

FIG. 10 illustrates a network in accordance with various embodiments.

FIG. 11 schematically illustrates a wireless network in accordance with various embodiments.

FIG. 12 is a block diagram illustrating components, according to some example embodiments, able to read instructions from a machine-readable or computer-readable medium (e.g., a non-transitory machine-readable storage medium) and perform any one or more of the methodologies discussed herein.

FIG. 13 depicts an example procedure for practicing the various embodiments discussed herein.

FIG. 14 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

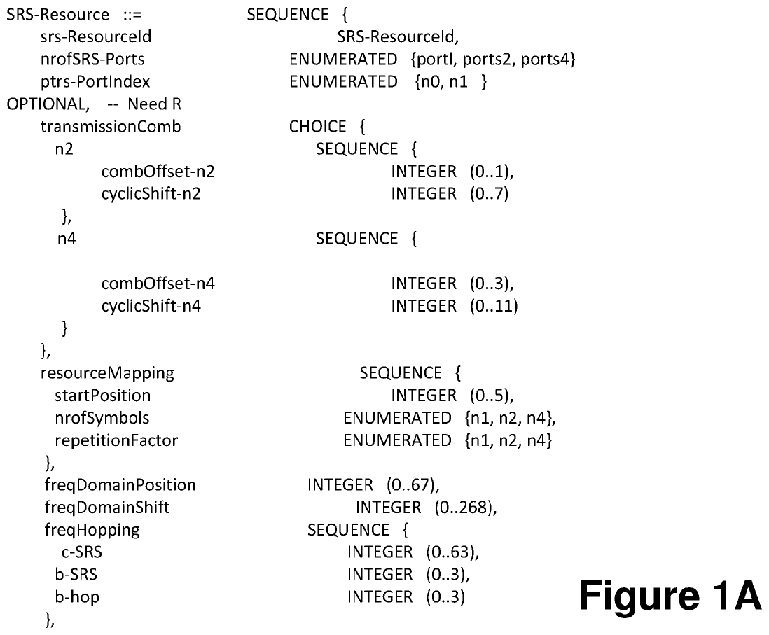

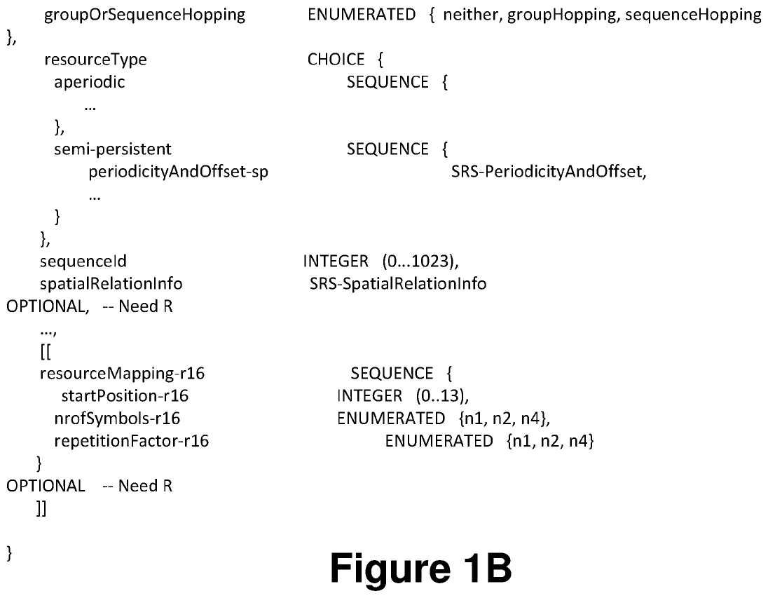

As discussed above, in NR release (Rel)-15, Rel-16, and Rel-17, up to 4 transmit (Tx) ports are supported for sounding reference signal (SRS) operation. The number of ports for SRS transmission is configured by radio resource control (RRC) parameter nrofSRS-Ports, as shown in FIGS. 1A and 1B.

In future specifications, e.g., Rel-18, uplink transmission may support up to 8 Tx ports. In various embodiments herein, SRS transmission may also support 8 port operation.

Various embodiments herein provide techniques to support SRS transmission with more than 4 Tx ports, e.g., 8-port operation. For example, to support 8-port SRS, one SRS resource with multiple OFDM symbols may be configured. Alternatively, multiple SRS resources may be configured to enable 8-port operation.

Note that the embodiments described herein may be applied to any SRS usage, such as codebook, non-codebook, antenna switching, and/or beam management.

8 Port SRS Operation with Single SRS Resource and Multiple OFDM Symbols

In an embodiment, for SRS with 8-ports, one SRS resource could be configured with multiple OFDM symbols, e.g., N∈{2, 4, 6, 8 . . . }, to support 8-ports operation, where N is the number of OFDM symbols. The OFDM symbols for SRS could be split into multiple subsets, e.g., two subsets. Both subsets are for 4-ports operation, and each subset is connected to different UE antenna ports/antennas.

For different subset of OFDM symbols, the same set of cyclic shifts or different set of cyclic shifts could be used.

In addition, the UE antenna ports/antennas could be split into multiple antenna port groups/antenna groups/panels, for example, antenna port #0 to #3 is the first antenna port group, and antenna port #4 to #7 is the second antenna port group. In this case, the first subset of the SRS OFDM symbols is for the first antenna port group (port #0 to #3), and the second subset of SRS OFDM symbols is for the second antenna port group (port #4 to #7).

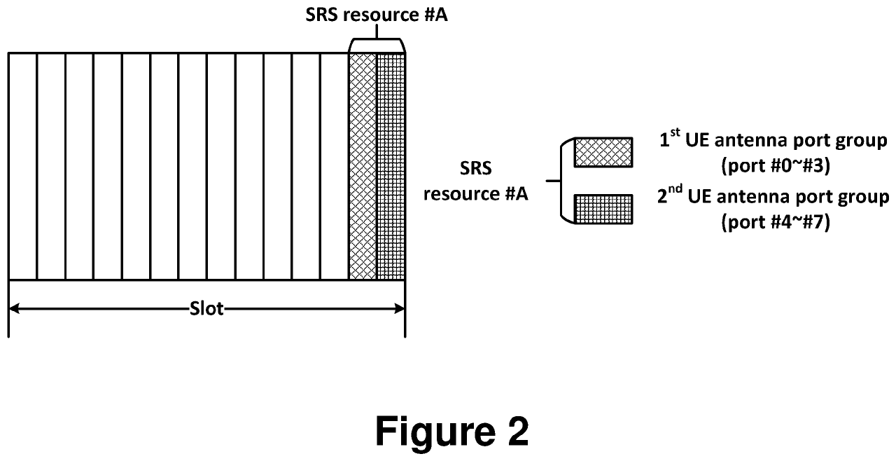

FIG. 2 shows an example of the operation.

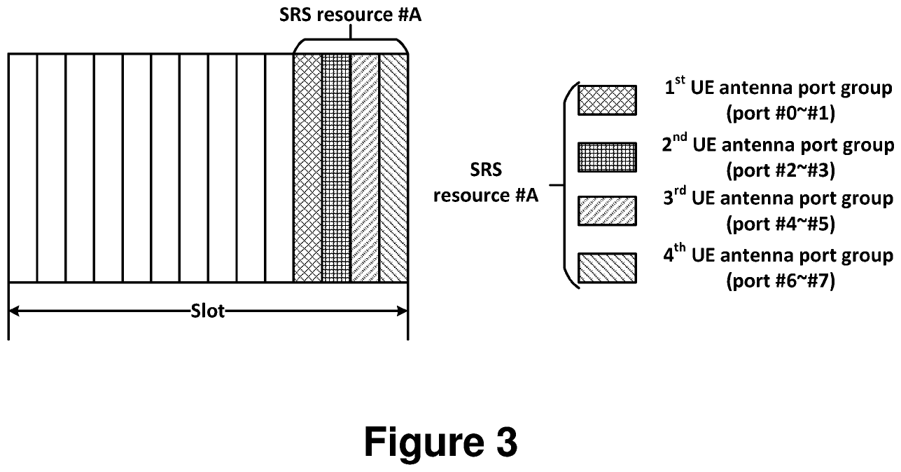

In another example, the SRS resource with 8-ports could be configured with 4 OFDM symbols, and each OFDM symbol is mapped with 2 ports. The 2-ports over different OFDM symbol are connected to different UE antenna port. FIG. 3 shows an example of the operation.

In another embodiment, for 8-port SRS with multiple OFDM symbols, the repetition could be configured for SRS.

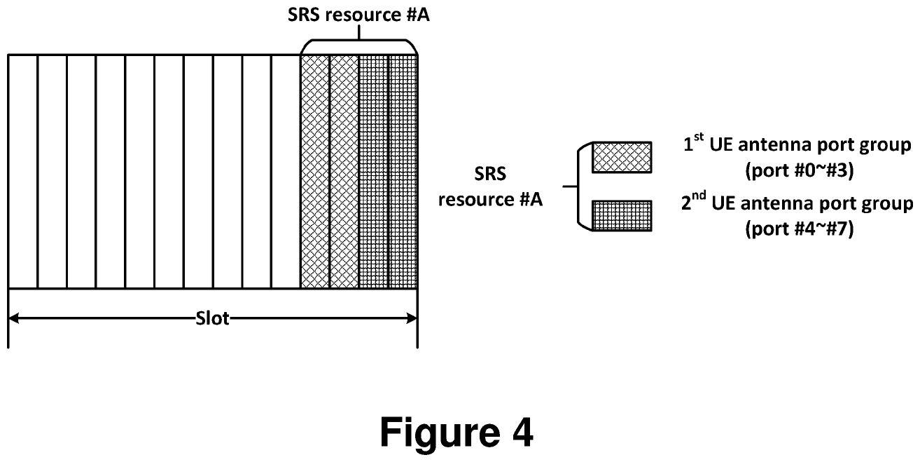

In one example, the SRS OFDM symbols (N symbols) could be divided into multiple subsets, e.g., two subsets. Each subset consists of N/2 consecutive OFDM symbols, e.g., the SRS ports are mapped onto OFDM symbols in half-half manner. FIG. 4 shows an example of the operation.

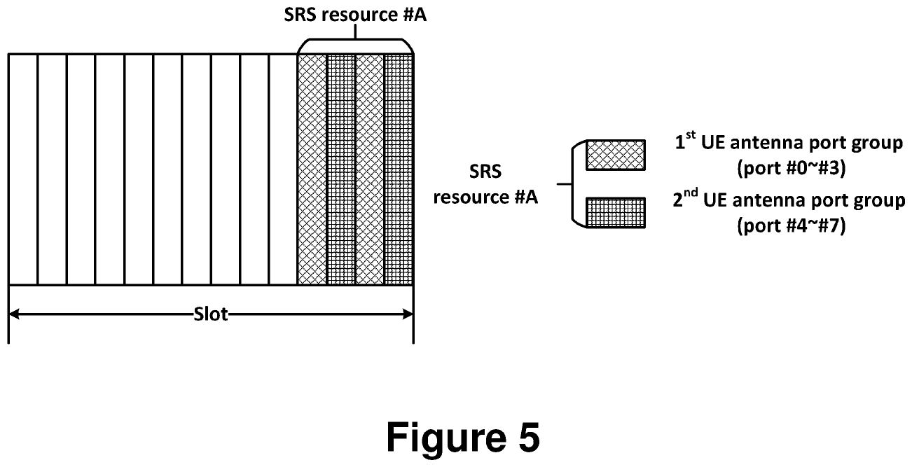

In another example, the OFDM symbols are mapped to different UE antenna ports in interlaced (or cyclical manner) manner. FIG. 5 shows an example of the operation.

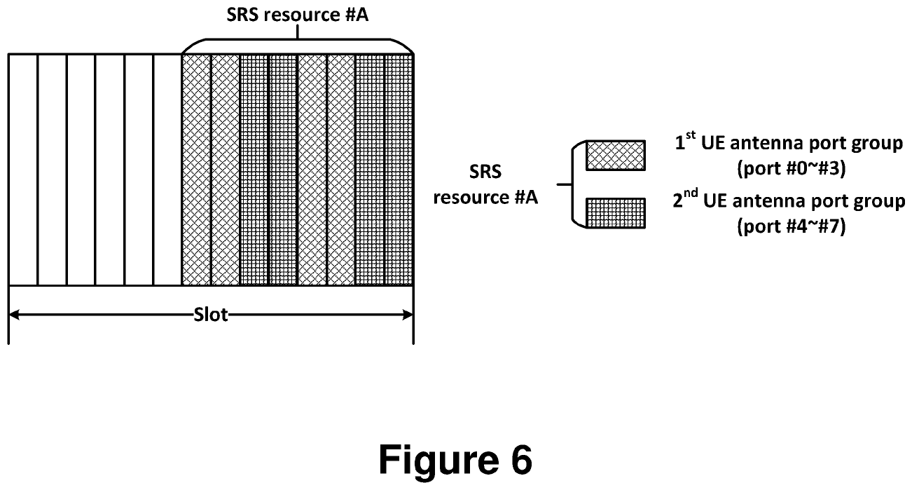

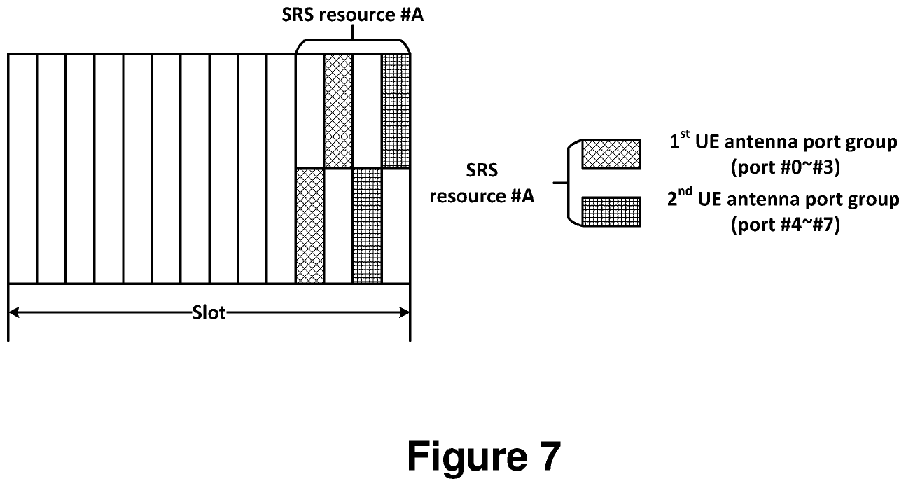

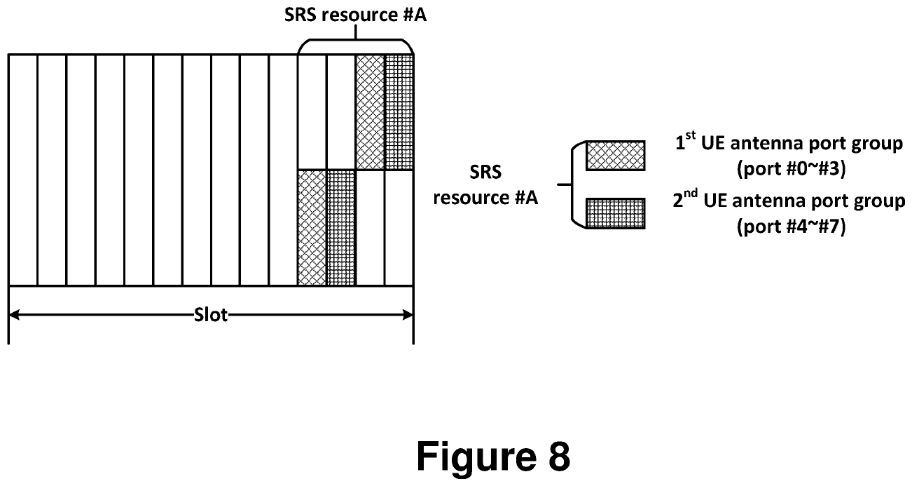

In another example, the SRS ports are mapped to OFDM symbols in sequential manner, e.g., the first four ports (port #0~#3) are mapped to the first two symbols, the second four ports (port #4~#7) are mapped to the second two symbols, and the same mapping pattern continues for the remaining OFDM symbols. FIG. 6 shows an example of the operation, wherein the 8-port SRS resource is configured with 8 OFDM symbols.

With multiple OFDM symbols, if the number of SRS ports mapped over one OFDM symbol is less than 8, for example, 4 ports or 2 ports (or even 1 port) are mapped onto one OFDM symbol, then the linear value of the transmit power determined by SRS power control should be equally split over the number of ports mapped over one OFDM symbol, instead of equally splitting over the configured ports for the SRS resource, e.g. 8 ports. For example, 4 ports are mapped onto one OFDM symbol for the 8-port SRS resource, then the transmit power should be equally split over 4 ports instead of equally splitting over 8 ports. In another example, 2 ports are mapped onto one OFDM symbol for the 8-port SRS resource, then the transmit power should be equally split over 2 ports instead of equally splitting over 8 ports.

In another embodiment, for 8-port SRS with multiple OFDM symbols, frequency hopping could be applied.

If the OFDM symbols are split into subsets with consecutive OFDM symbols, the frequency hopping operation is shown in FIG. 5.

If the OFDM symbols are mapped to different UE antenna ports in interlaced manner, the frequency hopping operation is shown in FIG. 6.

In another embodiment, for 8-port SRS with multiple OFDM symbols, the OFDM symbols for SRS could be within the same time slot or could be across different slots. If the OFDM symbols for SRS with 8-ports are across slots, the slots could be consecutive or non-consecutive.

8 Ports SRS Operation with Multiple SRS Resources

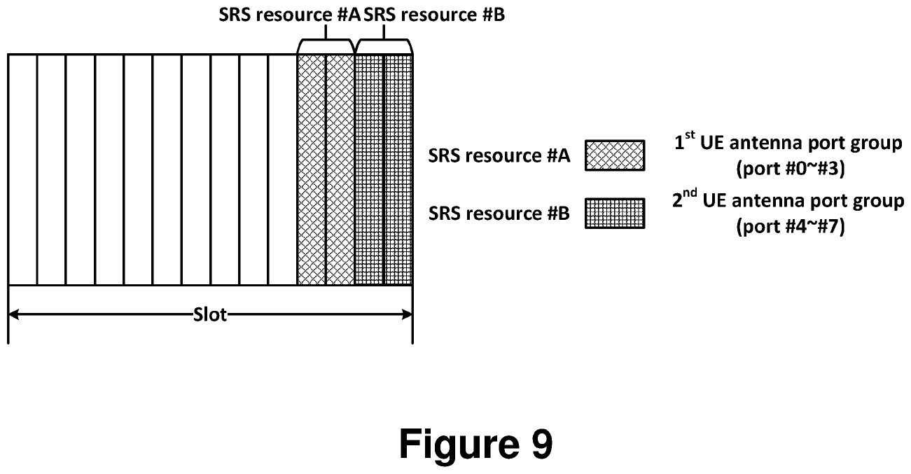

In an embodiment, for SRS with 8-ports, multiple SRS resources could be configured. For example, two SRS resources are configured, and each SRS resource is 4-ports. Each SRS resource is connected to different UE antenna ports/antenna port group. FIG. 9 shows an example of the operation.

In one example, the same frequency resource is configured for the two 4-port SRS resource. In another example, different frequency resource could be configured.

In one example, the two SRS resource occupy different time resource, e.g., different OFDM symbols. In another example, the two SRS resource occupy the same OFDM symbol(s) with different frequency resource.

In another embodiment, the same time domain behavior (aperiodic/periodic/semi-persistent) should be configured for the two 4-port SRS resources. The OFDM symbols for the two 4-port SRS resources could be adjacent or non-adjacent. The two 4-port SRS resources could be within the same time slot or in different time slot.

The same repetition factor and the same frequency hopping pattern and partial sounding pattern should be configured for the two 4-port SRS resources. In another example, different repetition factor/different frequency hopping/different partial sounding pattern could be configured for the two 4-port SRS resources.

In another embodiment, for 8-port SRS with multiple SRS resources, e.g., two 4-port SRS resources, one SRI could indicate multiple SRS resources. In the SRI field in DCI (e.g., 0_1/0_2), one code point of SRI field could indicate the two 4-port SRS resources. The mapping between SRI code point and SRS resources could be configured by RRC/MAC-CE.

All the code points of the SRI field could be mapped with multiple SRS resources. Or some code points of the SRI field could be mapped with multiple SRS resources and some code points are mapped with single SRS resource.

In another embodiment, for 8-port SRS with multiple SRS resources, e.g., two 4-port SRS resources, the linear value of the transmit power determined by SRS power control should be equally split over the number of ports configured for one SRS resource, e.g., 4 ports.

8 Port SRS Operation with Multiple SRS Resource Sets

In an embodiment, for SRS with 8-ports, multiple SRS resource sets could be configured, e.g., two SRS resource sets. Each SRS resource set consists of one SRS resource of 4-ports. Each SRS resource set is for different UE antenna ports/antenna port group.

The same time behavior (aperiodic, periodic, semi-persistent) should be configured for the two SRS resource sets. The same power control parameters should be configured for the two SRS resource sets. For aperiodic SRS, the same trigger state should be configured for the two SRS resource sets.

In DCI, two SRI field could be included, one for each SRS resource set. Alternatively, one SRI field is included in DCI, and one codepoint of SRI field could be mapped with SRS resource from two SRS resource sets. The mapping between SRI code point and SRS resources could be configured by RRC/MAC-CE.

In another embodiment, for 8-port SRS with multiple SRS resource sets, e.g., two SRS resource sets and each SRS resource set consists of one SRS resource of 4-ports, the linear value of the transmit power determined by SRS power control should be equally split over the number of ports configured for one SRS resource, e.g., 4 ports.

### Systems And Implementations

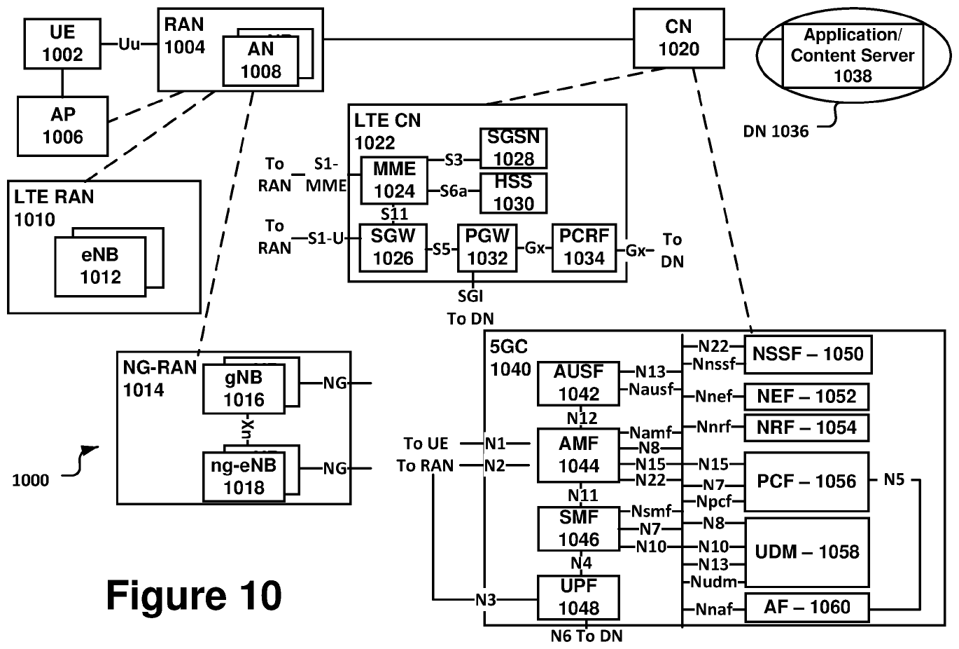

FIGS. 10-12 illustrate various systems, devices, and components that may implement aspects of disclosed embodiments.

FIG. 10 illustrates a network 1000 in accordance with various embodiments. The network 1000 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1000 may include a UE 1002, which may include any mobile or non-mobile computing device designed to communicate with a RAN 1004 via an over-the-air connection. The UE 1002 may be communicatively coupled with the RAN 1004 by a Uu interface. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1002 may additionally communicate with an AP 1006 via an over-the-air connection. The AP 1006 may manage a WLAN connection, which may serve to offload some/all network traffic from the RAN 1004. The connection between the UE 1002 and the AP 1006 may be consistent with any IEEE 802.11 protocol, wherein the AP 1006 could be a wireless fidelity (Wi-Fi®) router. In some embodiments, the UE 1002, RAN 1004, and AP 1006 may utilize cellular-WLAN aggregation (for example, LWA/LWIP). Cellular-WLAN aggregation may involve the UE 1002 being configured by the RAN 1004 to utilize both cellular radio resources and WLAN resources.

The RAN 1004 may include one or more access nodes, for example, AN 1008. AN 1008 may terminate air-interface protocols for the UE 1002 by providing access stratum protocols including RRC, PDCP, RLC, MAC, and L1 protocols. In this manner, the AN 1008 may enable data/voice connectivity between CN 1020 and the UE 1002. In some embodiments, the AN 1008 may be implemented in a discrete device or as one or more software entities running on server computers as part of, for example, a virtual network, which may be referred to as a CRAN or virtual baseband unit pool. The AN 1008 be referred to as a BS, gNB, RAN node, eNB, ng-eNB, NodeB, RSU, TRxP, TRP, etc. The AN 1008 may be a macrocell base station or a low power base station for providing femtocells, picocells or other like cells having smaller coverage areas, smaller user capacity, or higher bandwidth compared to macrocells.

In embodiments in which the RAN 1004 includes a plurality of ANs, they may be coupled with one another via an X2 interface (if the RAN 1004 is an LTE RAN) or an Xn interface (if the RAN 1004 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1004 may each manage one or more cells, cell groups, component carriers, etc. to provide the UE 1002 with an air interface for network access. The UE 1002 may be simultaneously connected with a plurality of cells provided by the same or different ANs of the RAN 1004. For example, the UE 1002 and RAN 1004 may use carrier aggregation to allow the UE 1002 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1004 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1002 or AN 1008 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1004 may be an LTE RAN 1010 with eNBs, for example, eNB 1012. The LTE RAN 1010 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1004 may be an NG-RAN 1014 with gNBs, for example, gNB 1016, or ng-eNBs, for example, ng-eNB 1018. The gNB 1016 may connect with 5G-enabled UEs using a 5G NR interface. The gNB 1016 may connect with a 5G core through an NG interface, which may include an N2 interface or an N3 interface. The ng-eNB 1018 may also connect with the 5G core through an NG interface, but may connect with a UE via an LTE air interface. The gNB 1016 and the ng-eNB 1018 may connect with each other over an Xn interface.

In some embodiments, the NG interface may be split into two parts, an NG user plane (NG-U) interface, which carries traffic data between the nodes of the NG-RAN 1014 and a UPF 1048 (e.g., N3 interface), and an NG control plane (NG-C) interface, which is a signaling interface between the nodes of the NG-RAN1014 and an AMF 1044 (e.g., N2 interface).

The NG-RAN 1014 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1002 can be configured with multiple BWPs where each BWP configuration has a different SCS. When a BWP change is indicated to the UE 1002, the SCS of the transmission is changed as well. Another use case example of BWP is related to power saving. In particular, multiple BWPs can be configured for the UE 1002 with different amount of frequency resources (for example, PRBs) to support data transmission under different traffic loading scenarios. A BWP containing a smaller number of PRBs can be used for data transmission with small traffic load while allowing power saving at the UE 1002 and in some cases at the gNB 1016. A BWP containing a larger number of PRBs can be used for scenarios with higher traffic load.

The RAN 1004 is communicatively coupled to CN 1020 that includes network elements to provide various functions to support data and telecommunications services to customers/subscribers (for example, users of UE 1002). The components of the CN 1020 may be implemented in one physical node or separate physical nodes. In some embodiments, NFV may be utilized to virtualize any or all of the functions provided by the network elements of the CN 1020 onto physical compute/storage resources in servers, switches, etc. A logical instantiation of the CN 1020 may be referred to as a network slice, and a logical instantiation of a portion of the CN 1020 may be referred to as a network sub-slice.

In some embodiments, the CN 1020 may be an LTE CN 1022, which may also be referred to as an EPC. The LTE CN 1022 may include MME 1024, SGW 1026, SGSN 1028, HSS 1030, PGW 1032, and PCRF 1034 coupled with one another over interfaces (or “reference points”) as shown. Functions of the elements of the LTE CN 1022 may be briefly introduced as follows.

The MME 1024 may implement mobility management functions to track a current location of the UE 1002 to facilitate paging, bearer activation/deactivation, handovers, gateway selection, authentication, etc.

The SGW 1026 may terminate an S1 interface toward the RAN and route data packets between the RAN and the LTE CN 1022. The SGW 1026 may be a local mobility anchor point for inter-RAN node handovers and also may provide an anchor for inter-3GPP mobility. Other responsibilities may include lawful intercept, charging, and some policy enforcement.

The SGSN 1028 may track a location of the UE 1002 and perform security functions and access control. In addition, the SGSN 1028 may perform inter-EPC node signaling for mobility between different RAT networks; PDN and S-GW selection as specified by MME 1024; MME selection for handovers; etc. The S3 reference point between the MME 1024 and the SGSN 1028 may enable user and bearer information exchange for inter-3GPP access network mobility in idle/active states.

The HSS 1030 may include a database for network users, including subscription-related information to support the network entities' handling of communication sessions. The HSS 1030 can provide support for routing/roaming, authentication, authorization, naming/addressing resolution, location dependencies, etc. An S6a reference point between the HSS 1030 and the MME 1024 may enable transfer of subscription and authentication data for authenticating/authorizing user access to the LTE CN 1020.

The PGW 1032 may terminate an SGi interface toward a data network (DN) 1036 that may include an application/content server 1038. The PGW 1032 may route data packets between the LTE CN 1022 and the data network 1036. The PGW 1032 may be coupled with the SGW 1026 by an S5 reference point to facilitate user plane tunneling and tunnel management. The PGW 1032 may further include a node for policy enforcement and charging data collection (for example, PCEF). Additionally, the SGi reference point between the PGW 1032 and the data network 10 36 may be an operator external public, a private PDN, or an intra-operator packet data network, for example, for provision of IMS services. The PGW 1032 may be coupled with a PCRF 1034 via a Gx reference point.

The PCRF 1034 is the policy and charging control element of the LTE CN 1022. The PCRF 1034 may be communicatively coupled to the app/content server 1038 to determine appropriate QoS and charging parameters for service flows. The PCRF 1032 may provision associated rules into a PCEF (via Gx reference point) with appropriate TFT and QCI.

In some embodiments, the CN 1020 may be a 5GC 1040. The 5GC 1040 may include an AUSF 1042, AMF 1044, SMF 1046, UPF 1048, NSSF 1050, NEF 1052, NRF 1054, PCF 1056, UDM 1058, and AF 1060 coupled with one another over interfaces (or “reference points”) as shown. Functions of the elements of the 5GC 1040 may be briefly introduced as follows.

The AUSF 1042 may store data for authentication of UE 1002 and handle authentication-related functionality. The AUSF 1042 may facilitate a common authentication framework for various access types. In addition to communicating with other elements of the 5GC 1040 over reference points as shown, the AUSF 1042 may exhibit an Nausf service-based interface.

The AMF 1044 may allow other functions of the 5GC 1040 to communicate with the UE 1002 and the RAN 1004 and to subscribe to notifications about mobility events with respect to the UE 1002. The AMF 1044 may be responsible for registration management (for example, for registering UE 1002), connection management, reachability management, mobility management, lawful interception of AMF-related events, and access authentication and authorization. The AMF 1044 may provide transport for SM messages between the UE 1002 and the SMF 1046, and act as a transparent proxy for routing SM messages. AMF 1044 may also provide transport for SMS messages between UE 1002 and an SMSF. AMF 1044 may interact with the AUSF 1042 and the UE 1002 to perform various security anchor and context management functions. Furthermore, AMF 1044 may be a termination point of a RAN CP interface, which may include or be an N2 reference point between the RAN 1004 and the AMF 1044; and the AMF 1044 may be a termination point of NAS (N1) signaling, and perform NAS ciphering and integrity protection. AMF 1044 may also support NAS signaling with the UE 1002 over an N3 IWF interface.

The SMF 1046 may be responsible for SM (for example, session establishment, tunnel management between UPF 1048 and AN 1008); UE IP address allocation and management (including optional authorization); selection and control of UP function; configuring traffic steering at UPF 1048 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1044 over N2 to AN 1008; and determining SSC mode of a session. SM may refer to management of a PDU session, and a PDU session or “session” may refer to a PDU connectivity service that provides or enables the exchange of PDUs between the UE 1002 and the data network 1036.

The UPF 1048 may act as an anchor point for intra-RAT and inter-RAT mobility, an external PDU session point of interconnect to data network 1036, and a branching point to support multi-homed PDU session. The UPF 1048 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1048 may include an uplink classifier to support routing traffic flows to a data network.

The NSSF 1050 may select a set of network slice instances serving the UE 1002. The NSSF 1050 may also determine allowed NSSAI and the mapping to the subscribed S-NSSAIs, if needed. The NSSF 1050 may also determine the AMF set to be used to serve the UE 1002, or a list of candidate AMFs based on a suitable configuration and possibly by querying the NRF 1054. The selection of a set of network slice instances for the UE 1002 may be triggered by the AMF 1044 with which the UE 1002 is registered by interacting with the NSSF 1050, which may lead to a change of AMF. The NSSF 1050 may interact with the AMF 1044 via an N22 reference point; and may communicate with another NSSF in a visited network via an N31 reference point (not shown). Additionally, the NSSF 1050 may exhibit an Nnssf service-based interface.

The NEF 1052 may securely expose services and capabilities provided by 3GPP network functions for third party, internal exposure/re-exposure, AFs (e.g., AF 1060), edge computing or fog computing systems, etc. In such embodiments, the NEF 1052 may authenticate, authorize, or throttle the AFs. NEF 1052 may also translate information exchanged with the AF 1060 and information exchanged with internal network functions. For example, the NEF 1052 may translate between an AF-Service-Identifier and an internal 5GC information. NEF 1052 may also receive information from other NFs based on exposed capabilities of other NFs. This information may be stored at the NEF 1052 as structured data, or at a data storage NF using standardized interfaces. The stored information can then be re-exposed by the NEF 1052 to other NFs and AFs, or used for other purposes such as analytics. Additionally, the NEF 1052 may exhibit an Nnef service-based interface.

The NRF 1054 may support service discovery functions, receive NF discovery requests from NF instances, and provide the information of the discovered NF instances to the NF instances. NRF 1054 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1054 may exhibit the Nnrf service-based interface.

The PCF 1056 may provide policy rules to control plane functions to enforce them, and may also support unified policy framework to govern network behavior. The PCF 1056 may also implement a front end to access subscription information relevant for policy decisions in a UDR of the UDM 1058. In addition to communicating with functions over reference points as shown, the PCF 1056 exhibit an Npcf service-based interface.

The UDM 1058 may handle subscription-related information to support the network entities' handling of communication sessions, and may store subscription data of UE 1002. For example, subscription data may be communicated via an N8 reference point between the UDM 1058 and the AMF 1044. The UDM 1058 may include two parts, an application front end and a UDR. The UDR may store subscription data and policy data for the UDM 1058 and the PCF 1056, and/or structured data for exposure and application data (including PFDs for application detection, application request information for multiple UEs 1002) for the NEF 1052. The Nudr service-based interface may be exhibited by the UDR 221 to allow the UDM 1058, PCF 1056, and NEF 1052 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1058 may exhibit the Nudm service-based interface.

The AF 1060 may provide application influence on traffic routing, provide access to NEF, and interact with the policy framework for policy control.

In some embodiments, the 5GC 1040 may enable edge computing by selecting operator/3^{rd} party services to be geographically close to a point that the UE 1002 is attached to the network. This may reduce latency and load on the network. To provide edge-computing implementations, the 5GC 1040 may select a UPF 1048 close to the UE 1002 and execute traffic steering from the UPF 1048 to data network 1036 via the N6 interface. This may be based on the UE subscription data, UE location, and information provided by the AF 1060. In this way, the AF 1060 may influence UPF (re) selection and traffic routing. Based on operator deployment, when AF 1060 is considered to be a trusted entity, the network operator may permit AF 1060 to interact directly with relevant NFs. Additionally, the AF 1060 may exhibit an Naf service-based interface.

The data network 1036 may represent various network operator services, Internet access, or third party services that may be provided by one or more servers including, for example, application/content server 1038.

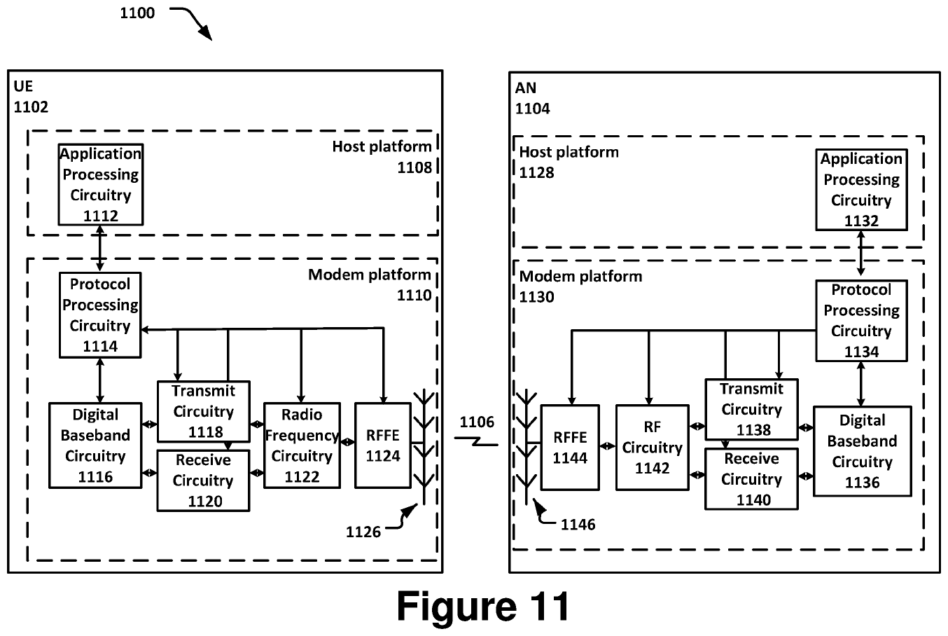

FIG. 11 schematically illustrates a wireless network 1100 in accordance with various embodiments. The wireless network 1100 may include a UE 1102 in wireless communication with an AN 1104. The UE 1102 and AN 1104 may be similar to, and substantially interchangeable with, like-named components described elsewhere herein.

The UE 1102 may be communicatively coupled with the AN 1104 via connection 1106. The connection 1106 is illustrated as an air interface to enable communicative coupling, and can be consistent with cellular communications protocols such as an LTE protocol or a 5G NR protocol operating at mm Wave or sub-6 GHZ frequencies.

The UE 1102 may include a host platform 1108 coupled with a modem platform 1110. The host platform 1108 may include application processing circuitry 1112, which may be coupled with protocol processing circuitry 1114 of the modem platform 1110. The application processing circuitry 1112 may run various applications for the UE 1102 that source/sink application data. The application processing circuitry 1112 may further implement one or more layer operations to transmit/receive application data to/from a data network. These layer operations may include transport (for example UDP) and Internet (for example, IP) operations

The protocol processing circuitry 1114 may implement one or more of layer operations to facilitate transmission or reception of data over the connection 1106. The layer operations implemented by the protocol processing circuitry 1114 may include, for example, MAC, RLC, PDCP, RRC and NAS operations.

The modem platform 1110 may further include digital baseband circuitry 1116 that may implement one or more layer operations that are “below” layer operations performed by the protocol processing circuitry 1114 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1110 may further include transmit circuitry 1118, receive circuitry 1120, RF circuitry 1122, and RF front end (RFFE) 1124, which may include or connect to one or more antenna panels 1126. Briefly, the transmit circuitry 1118 may include a digital-to-analog converter, mixer, intermediate frequency (IF) components, etc.; the receive circuitry 1120 may include an analog-to-digital converter, mixer, IF components, etc.; the RF circuitry 1122 may include a low-noise amplifier, a power amplifier, power tracking components, etc.; RFFE 1124 may include filters (for example, surface/bulk acoustic wave filters), switches, antenna tuners, beamforming components (for example, phase-array antenna components), etc. The selection and arrangement of the components of the transmit circuitry 1118, receive circuitry 1120, RF circuitry 1122, RFFE 1124, and antenna panels 1126 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1114 may include one or more instances of control circuitry (not shown) to provide control functions for the transmit/receive components.

A UE reception may be established by and via the antenna panels 1126, RFFE 1124, RF circuitry 1122, receive circuitry 1120, digital baseband circuitry 1116, and protocol processing circuitry 1114. In some embodiments, the antenna panels 1126 may receive a transmission from the AN 1104 by receive-beamforming signals received by a plurality of antennas/antenna elements of the one or more antenna panels 1126.

A UE transmission may be established by and via the protocol processing circuitry 1114, digital baseband circuitry 1116, transmit circuitry 1118, RF circuitry 1122, RFFE 1124, and antenna panels 1126. In some embodiments, the transmit components of the UE 1104 may apply a spatial filter to the data to be transmitted to form a transmit beam emitted by the antenna elements of the antenna panels 1126.

Similar to the UE 1102, the AN 1104 may include a host platform 1128 coupled with a modem platform 1130. The host platform 1128 may include application processing circuitry 1132 coupled with protocol processing circuitry 1134 of the modem platform 1130. The modem platform may further include digital baseband circuitry 1136, transmit circuitry 1138, receive circuitry 1140, RF circuitry 1142, RFFE circuitry 1144, and antenna panels 1146. The components of the AN 1104 may be similar to and substantially interchangeable with like-named components of the UE 1102. In addition to performing data transmission/reception as described above, the components of the AN 1108 may perform various logical functions that include, for example, RNC functions such as radio bearer management, uplink and downlink dynamic radio resource management, and data packet scheduling.

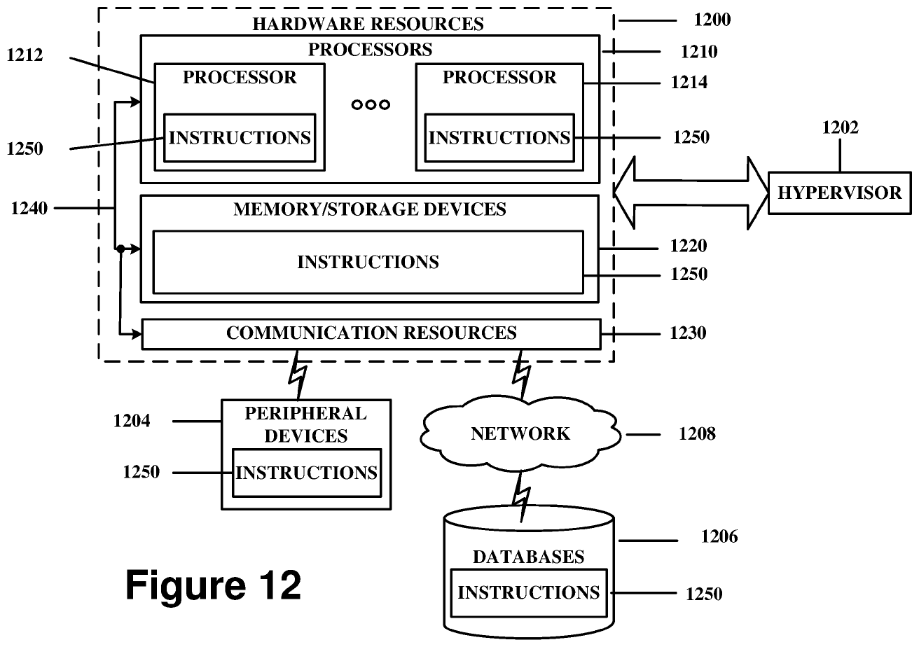

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240 or other interface circuitry. For embodiments where node virtualization (e.g., NFV) is utilized, a hypervisor 1202 may be executed to provide an execution environment for one or more network slices/sub-slices to utilize the hardware resources 1200.

The processors 1210 may include, for example, a processor 1212 and a processor 1214. The processors 1210 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1220 may include main memory, disk storage, or any suitable combination thereof. The memory/storage devices 1220 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1230 may include interconnection or network interface controllers, components, or other suitable devices to communicate with one or more peripheral devices 1204 or one or more databases 1206 or other network elements via a network 1208. For example, the communication resources 1230 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

### Example Procedures

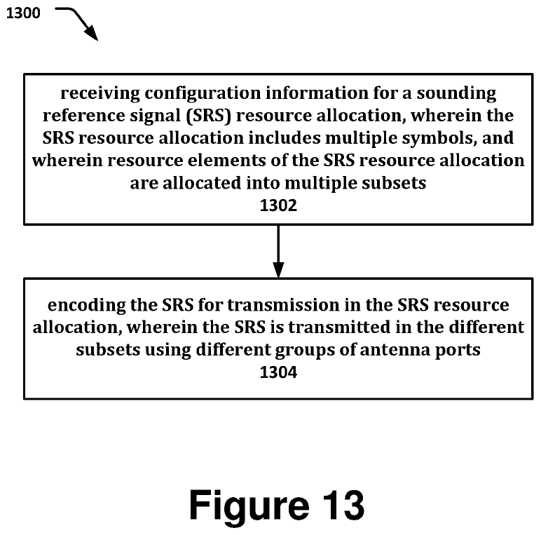

In some embodiments, the electronic device(s), network(s), system(s), chip(s) or component(s), or portions or implementations thereof, of FIGS. 10-12, or some other figure herein, may be configured to perform one or more processes, techniques, or methods as described herein, or portions thereof. One such process 1300 is depicted in FIG. 13. The process 1300 may be performed by a UE or a portion thereof. For example, the process 1300 may include, at 1302, receiving configuration information for a sounding reference signal (SRS) resource allocation, wherein the SRS resource allocation includes multiple symbols, and wherein resource elements of the SRS resource allocation are allocated into multiple subsets. For example, the subsets may each include one or more symbols. The symbols of the different subsets may be interlaced with one another within a slot (e.g., as shown in FIG. 5 or FIG. 6) or grouped together (e.g., as shown in FIG. 4).

At 1304, the process 1300 may further include encoding the SRS for transmission in the SRS resource allocation, wherein the SRS is transmitted in the different subsets using different groups of antenna ports. In some embodiments, a total transmit power of the SRS in a respective symbol may be divided equally among the antenna ports on which the SRS is transmitted in the respective symbol. For example, the SRS may be transmitted using eight total antenna ports divided into a first group of antenna ports and a second group of antenna ports that each include four antenna ports. If the SRS is transmitted in a first symbol with the first group of antenna ports (and not the second group of antenna ports) then a total transmission power in that symbol is divided equally among the four antenna ports of the first group of antenna ports.

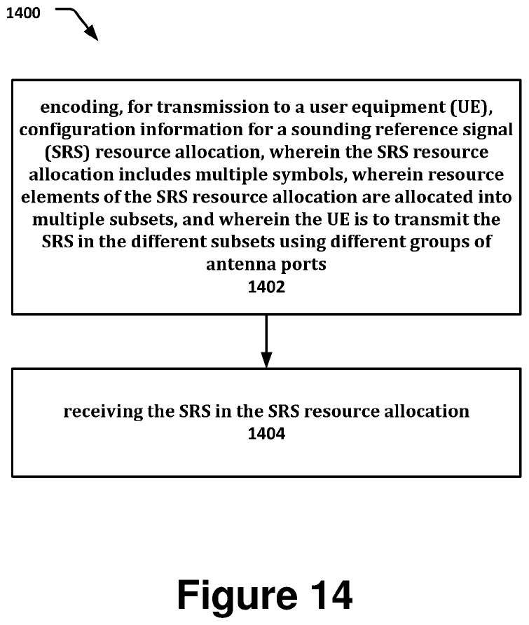

FIG. 14 illustrates another process 1400 in accordance with various embodiments. The process 1400 may be performed by a gNB or a portion thereof. For example, at 1402, the process 1400 may include encoding, for transmission to a user equipment (UE), configuration information for a sounding reference signal (SRS) resource allocation, wherein the SRS resource allocation includes multiple symbols, wherein resource elements of the SRS resource allocation are allocated into multiple subsets, and wherein the UE is to transmit the SRS in the different subsets using different groups of antenna ports. For example, the subsets may each include one or more symbols. The symbols of the different subsets may be interlaced with one another within a slot (e.g., as shown in FIG. 5 or FIG. 6) or grouped together (e.g., as shown in FIG. 4). At 1404, the process 1400 may further include receiving the SRS in the SRS resource allocation.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Some non-limiting examples of various embodiments are provided below.

Example A1 may include an apparatus to be implemented in a user equipment (UE), the apparatus comprising: a memory to store configuration information for a sounding reference signal (SRS) resource allocation, wherein the SRS resource allocation includes multiple symbols, and wherein resource elements of the SRS resource allocation are allocated into multiple subsets; and processor circuitry coupled to the memory, the processor circuitry to encode the SRS for transmission in the SRS resource allocation, wherein the SRS is transmitted in the different subsets using different groups of antenna ports.

Example A2 may include the apparatus of example A1, wherein the subsets each include one or more symbols of the multiple symbols.

Example A3 may include the apparatus of example A2, wherein the subsets each include two or more of the symbols, and wherein the symbols of the subsets are interlaced with one another.

Example A4 may include the apparatus of example A2, wherein the processor circuitry is further to equally divide a total transmit power among the group of antenna ports that is used to transmit the SRS in the respective symbol of the subset.

Example A5 may include the apparatus of example A1, wherein the SRS is transmitted in the different subsets using a same set of cyclic shifts or different sets of cyclic shifts.

Example A6 may include the apparatus of example A1, wherein the SRS is transmitted using frequency hopping within the individual subsets.

Example A7 may include the apparatus of any one of examples A1-A6, wherein the SRS is transmitted with a total of 8 antenna ports.

Example A8 may include the apparatus of example A7, wherein the multiple subsets is two subsets, and wherein the SRS is transmitted on each of the two subsets using 4 antenna ports.

Example A9 may include one or more non-transitory computer-readable media (NTCRM) having instructions, stored thereon, that when executed by one or more processors of a next generation Node B (gNB) configure the gNB to: encode, for transmission to a user equipment (UE), configuration information for a sounding reference signal (SRS) resource allocation, wherein the SRS resource allocation includes multiple symbols, wherein resource elements of the SRS resource allocation are allocated into multiple subsets, and wherein the UE is to transmit the SRS in the different subsets using different groups of antenna ports; and receive the SRS in the SRS resource allocation.

Example A10 may include the one or more NTCRM of example A9, wherein the subsets each include one or more symbols of the multiple symbols.

Example A11 may include the one or more NTCRM of example A10, wherein the subsets each include two or more of the symbols, and wherein the symbols of the subsets are interlaced with one another.

Example A12 may include the one or more NTCRM of example A9, wherein a total transmit power is divided equally among the group of antenna ports that is used to transmit the SRS in the respective symbol of the subset.

Example A13 may include the one or more NTCRM of example A9, wherein the SRSs in the different subsets use a same set of cyclic shifts or different sets of cyclic shifts.

Example A14 may include the one or more NTCRM example A9, wherein the SRS is received using frequency hopping within the individual subsets.

Example A15 may include the one or more NTCRM of any one of examples A9-A14, wherein the SRS is transmitted with a total of 8 antenna ports.

Example A16 may include the one or more NTCRM of example A15, wherein the multiple subsets is two subsets, and wherein the SRS is transmitted on each of the two subsets using 4 antenna ports.

Example A17 may include one or more non-transitory computer-readable media (NTCRM) having instructions, stored thereon, that when executed by one or more processors of a user equipment (UE) configure the UE to: receive configuration information for a sounding reference signal (SRS) resource allocation, wherein the SRS resource allocation includes a first subset of symbols that are allocated to a first group of antenna ports and a second subset of symbols that are allocated to a second group of antenna ports, wherein the first and second subsets of symbols are non-overlapping; and transmit the SRS in the first subset of symbols using the first group of antenna ports and in the second subset of symbols using the second group of antenna ports, wherein a total transmit power for the SRS in a respective symbol of the first or second subset of symbols is divided equally among the antenna ports that are used to transmit the SRS in the respective symbol.

Example A18 may include the one or more NTCRM of example A17, wherein the first and second subsets of symbols are interlaced with one another within a slot.

Example A19 may include the one or more NTCRM of example A17, wherein the SRS is transmitted in the second subset of symbols using a same set of cyclic shifts or a different set of cyclic shifts than in the first subset of symbols.

Example A20 may include the one or more NTCRM of any one of examples A17-A19, wherein the first and second groups of antenna ports each include four antenna ports.

Example B1 may include a method of a gNB or a UE, wherein the gNB configures the UE with SRS transmission as described herein.

Example B2 may include the method of example B1 or some other example herein, wherein for SRS with 8-ports, one SRS resource could be configured with multiple OFDM symbols, e.g., NE {2, 4, 6, 8 . . . }, to support 8-ports operation, where N is the number of OFDM symbols. The OFDM symbols for SRS could be split into multiple subsets, e.g., two subsets. Both subsets are for 4-ports operation, and each subset is connected to different UE antenna ports/antennas.

Example B3 may include the method of example B2 or some other example herein, wherein for different subset of OFDM symbols, the same set of cyclic shifts or different set of cyclic shifts could be used. The UE antenna ports/antennas could be split into multiple antenna port groups/antenna groups/panels. The first subset of the SRS OFDM symbols is for the first antenna port group, and the second subset of SRS OFDM symbols is for the second antenna port group.

Example B4 may include the method of example B2 or some other example herein, wherein for 8-port SRS with multiple OFDM symbols, the repetition could be configured for SRS. The SRS OFDM symbols (N symbols) could be divided into multiple subsets, e.g., two subsets. Each subset consists of N/2 consecutive OFDM symbols. Or the OFDM symbols are mapped to different UE antenna ports in interlaced manner.

Example B5 may include the method of example B2 or some other example herein, wherein for 8-port SRS with multiple OFDM symbols, frequency hopping could be applied. The operation could be as shown in FIG. 5 and FIG. 6.

Example B6 may include the method of example B2 or some other example herein, wherein for 8-port SRS with multiple OFDM symbols, the OFDM symbols for SRS could be within the same time slot or could be across different slots. If the OFDM symbols for SRS with 8-ports are across slots, the slots could be consecutive or non-consecutive.

Example B7 may include the method of example B1 or some other example herein, wherein for SRS with 8-ports, multiple SRS resources could be configured. For example, two SRS resources are configured, and each SRS resource is 4-ports. Each SRS resource is connected to different UE antenna ports/antenna port group. The same/different time/frequency resource could be configured for the two 4-port SRS resources.

Example B8 may include the method of example B7 or some other example herein, wherein the same time domain behavior (aperiodic/periodic/semi-persistent) should be configured for the two 4-port SRS resources. The OFDM symbols for the two 4-port SRS resources could be adjacent or non-adjacent. The two 4-port SRS resources could be within the same time slot or in different time slot. The same/different repetition factor and the same/different frequency hopping pattern and partial sounding pattern should be configured for the two 4-port SRS resources.

Example B9 may include the method of example B7 or some other example herein, wherein for 8-port SRS with multiple SRS resources, e.g., two 4-port SRS resources, one SRI could indicate multiple SRS resources. In the SRI field in DCI (e.g., 0_1/0_2), one code point of SRI field could indicate the two 4-port SRS resources. The mapping between SRI code point and SRS resources could be configured by RRC/MAC-CE. All the code points of the SRI field could be mapped with multiple SRS resources. Or some code points of the SRI field could be mapped with multiple SRS resources and some code points are mapped with single SRS resource.

Example B10 may include the method of example B1 or some other example herein, wherein for SRS with 8-ports, multiple SRS resource sets could be configured, e.g., two SRS resource sets. Each SRS resource set consists of one SRS resource of 4-ports. Each SRS resource set is for different UE antenna ports/antenna port group. The same time behavior (aperiodic, periodic, semi-persistent) should be configured for the two SRS resource sets. The same power control parameters should be configured for the two SRS resource sets. For aperiodic SRS, the same trigger state should be configured for the two SRS resource sets. In DCI, two SRI field could be included, one for each SRS resource set. Alternatively, one SRI field is included in DCI, and one codepoint of SRI field could be mapped with SRS resource from two SRS resource sets. The mapping between SRI code point and SRS resources could be configured by RRC/MAC-CE.

Example B11 may include a method of a UE, the method comprising: receiving configuration information for a sounding reference signal (SRS) resource allocation, wherein the SRS resource allocation includes multiple symbols, and wherein resource elements of the SRS resource allocation are allocated into multiple subsets; and encoding the SRS for transmission in the SRS resource allocation, wherein the SRS is transmitted in the different subsets using different groups of antenna ports.

Example B12 may include the method of example B11 or some other example herein, wherein the SRS is transmitted with a total of 8 antenna ports.

Example B13 may include the method of example B12 or some other example herein, wherein the multiple subsets is two subsets, and wherein the SRS is transmitted on each of the two subsets using 4 antenna ports.

Example B14 may include the method of example B11-B13 or some other example herein, wherein the SRS is transmitted in the different subsets using a same set of cyclic shifts.

Example B15 may include the method of example B11-B13 or some other example herein, wherein the SRS is transmitted in the different subsets using different sets of cyclic shifts.

Example B16 may include the method of example B11-B15 or some other example herein, wherein the subsets each include one or more whole symbols of the multiple symbols.

Example B17 may include the method of example B11-B15 or some other example herein, wherein the SRS is transmitted using frequency hopping within the individual subsets.

Example B18 may include the method of example B11-B17 or some other example herein, wherein the subsets are interlaced with one another.

Example B19 may include the method of example B11-B18 or some other example herein, wherein the SRS is transmitted with repetitions.

Example B20 may include the method of example B11-B19 or some other example herein, wherein the symbols are in a same slot or in different slots (e.g., consecutive or non-consecutive slots).

Example B21 may include the method of example B11-B20 or some other example herein, wherein the symbols are consecutive or non-consecutive.

Example B22 may include a method of a gNB, the method comprising: encoding, for transmission to a UE, configuration information for a sounding reference signal (SRS) resource allocation, wherein the SRS resource allocation includes multiple symbols, wherein resource elements of the SRS resource allocation are allocated into multiple subsets, and wherein the UE is to transmit the SRS in the different subsets using different groups of antenna ports; and receiving the SRS in the SRS resource allocation.

Example B23 may include the method of example B22 or some other example herein, wherein the SRS is transmitted with a total of 8 antenna ports.

Example B24 may include the method of example B23 or some other example herein, wherein the multiple subsets is two subsets, and wherein the SRS is transmitted on each of the two subsets using 4 antenna ports.

Example B25 may include the method of example B22-B24 or some other example herein, wherein the SRS is received in the different subsets using a same set of cyclic shifts.

Example B26 may include the method of example B22-B24 or some other example herein, wherein the SRS is received in the different subsets using different sets of cyclic shifts.

Example B27 may include the method of example B22-B26 or some other example herein, wherein the subsets each include one or more whole symbols of the multiple symbols.

Example B28 may include the method of example B22-B26 or some other example herein, wherein the SRS is transmitted using frequency hopping within the individual subsets.

Example B29 may include the method of example B22-B28 or some other example herein, wherein the subsets are interlaced with one another.

Example B30 may include the method of example B22-B29 or some other example herein, wherein the SRS is received with repetitions.

Example B31 may include the method of example B22-B30 or some other example herein, wherein the symbols are in a same slot or in different slots (e.g., consecutive or non-consecutive slots).

Example B32 may include the method of example B22-B31 or some other example herein, wherein the symbols are consecutive or non-consecutive.

Example Z01 may include an apparatus comprising means to perform one or more elements of a method described in or related to any of examples A1-A20, B1-B32, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A20, B1-B32, or any other method or process described herein.

Example Z03 may include an apparatus comprising logic, modules, or circuitry to perform one or more elements of a method described in or related to any of examples A1-A20, B1-B32, or any other method or process described herein.

Example Z04 may include a method, technique, or process as described in or related to any of examples A1-A20, B1-B32, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A20, B1-B32, or portions thereof.

Example Z06 may include a signal as described in or related to any of examples A1-A20, B1-B32, or portions or parts thereof.

Example Z07 may include a datagram, packet, frame, segment, protocol data unit (PDU), or message as described in or related to any of examples A1-A20, B1-B32, or portions or parts thereof, or otherwise described in the present disclosure.

Example Z08 may include a signal encoded with data as described in or related to any of examples A1-A20, B1-B32, or portions or parts thereof, or otherwise described in the present disclosure.

Example Z09 may include a signal encoded with a datagram, packet, frame, segment, protocol data unit (PDU), or message as described in or related to any of examples A1-A20, B1-B32, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A20, B1-B32, or portions thereof.

Example Z11 may include a computer program comprising instructions, wherein execution of the program by a processing element is to cause the processing element to carry out the method, techniques, or process as described in or related to any of examples A1-A20, B1-B32, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS |
| | Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language, Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE |
| | Radio Access Network |
| GGSN | Gateway GPRS Support Node |
| GLONASS | GLObal'naya NAvigatsionnaya Sputnikovaya |
| | Sistema (Engl.: Global Navigation Satellite |
| | System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, Groupe |
| | Spécial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPV4 | Internet Protocol Version 4 |
| IPV6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-IMAC | used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information |
| | Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSFCH | physical sidelink feedback channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block SSBRI SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VOIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. An apparatus to be implemented in a user equipment (UE), the apparatus comprising:
a memory to store configuration information for a sounding reference signal (SRS) resource allocation, wherein the SRS resource allocation includes multiple symbols, and wherein resource elements of the SRS resource allocation are allocated into multiple subsets; and
processor circuitry coupled to the memory, the processor circuitry to encode the SRS for transmission in the SRS resource allocation, wherein the SRS is transmitted in the different subsets using different groups of antenna ports.

22. The apparatus of claim 21, wherein the subsets each include one or more symbols of the multiple symbols.

23. The apparatus of claim 22, wherein the subsets each include two or more of the symbols, and wherein the symbols of the subsets are interlaced with one another.

24. The apparatus of claim 21, wherein the processor circuitry is further to equally divide a total transmit power among the group of antenna ports that is used to transmit the SRS in a symbol of the multiple symbols.

25. The apparatus of claim 21, wherein the SRS is transmitted in the different subsets using a same set of cyclic shifts or different sets of cyclic shifts.

26. The apparatus of claim 21, wherein the SRS is transmitted using frequency hopping within the individual subsets.

27. The apparatus of claim 21, wherein the SRS is transmitted with a total of 8 antenna ports.

28. The apparatus of claim 27, wherein the multiple subsets is two subsets, and wherein the SRS is transmitted on each of the two subsets using 4 antenna ports.

29. One or more non-transitory computer-readable media (NTCRM) having instructions, stored thereon, that when executed by one or more processors of a next generation Node B (gNB) configure the gNB to:
encode, for transmission to a user equipment (UE), configuration information for a sounding reference signal (SRS) resource allocation, wherein the SRS resource allocation includes multiple symbols, wherein resource elements of the SRS resource allocation are allocated into multiple subsets, and wherein the UE is to transmit the SRS in the different subsets using different groups of antenna ports; and
identify receipt of the SRS in the SRS resource allocation.

30. The one or more NTCRM of claim 29, wherein the subsets each include one or more symbols of the multiple symbols.

31. The one or more NTCRM of claim 30, wherein the subsets each include two or more of the symbols, and wherein the symbols of the subsets are interlaced with one another.

32. The one or more NTCRM of claim 29, wherein a total transmit power for a symbol of the multiple symbols is divided equally among the group of antenna ports that is used to transmit the SRS in the symbol.

33. The one or more NTCRM of claim 29, wherein the SRSs in the different subsets use a same set of cyclic shifts or different sets of cyclic shifts.

34. The one or more NTCRM claim 29, wherein the SRS is received using frequency hopping within the individual subsets.

35. The one or more NTCRM of claim 29, wherein the SRS is transmitted with a total of 8 antenna ports.

36. The one or more NTCRM of claim 35, wherein the multiple subsets is two subsets, and wherein the SRS is transmitted on each of the two subsets using 4 antenna ports.

37. One or more non-transitory computer-readable media (NTCRM) having instructions, stored thereon, that when executed by one or more processors of a user equipment (UE) configure the UE to:
receive configuration information for a sounding reference signal (SRS) resource allocation, wherein the SRS resource allocation includes a first subset of symbols that are allocated to a first group of antenna ports and a second subset of symbols that are allocated to a second group of antenna ports, wherein the first and second subsets of symbols are non-overlapping; and
transmit the SRS in the first subset of symbols using the first group of antenna ports and in the second subset of symbols using the second group of antenna ports, wherein a total transmit power for the SRS in a respective symbol of the first or second subset of symbols is divided equally among the antenna ports that are used to transmit the SRS in the respective symbol.

38. The one or more NTCRM of claim 37, wherein the first and second subsets of symbols are interlaced with one another within a slot.

39. The one or more NTCRM of claim 37, wherein the SRS is transmitted in the second subset of symbols using a same set of cyclic shifts or a different set of cyclic shifts than in the first subset of symbols.

40. The one or more NTCRM of claim 37, wherein the first and second groups of antenna ports each include four antenna ports.
